(19) United States
(12) Patent Application Publication
(10) Pub. No.: US 2007/0295231 A1
(43) Pub. Date: Dec. 27, 2007

(54) APPARATUS AND METHOD FOR CLEANING STENCILS EMPLOYED IN A SCREEN PRINTING APPARATUS

(75) Inventors: Isabel de Sousa, Quebec (CA); Robert Riel, Quebec (CA); Nicolas Tessier, Quebec (CA); Joel Tremblay, Quebec (CA)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 11/306,306

(22) Filed: Dec. 22, 2005

(30) Foreign Application Priority Data
Dec. 22, 2004 (CA) 2,490,665

(51) Int. Cl. B41F 35/00

(52) U.S. Cl. 101/425; 101/483

(57) ABSTRACT

A stencil printing method and apparatus for printing paste material in a given pattern on a substrate from a paste dispenser through a stencil to define the stencil pattern on a substrate. The apparatus is provided with a cleaning module that can be moved against the printing face of the stencil and moved, along a given path beneath the stencil, for cleaning the printing face of the stencil. The cleaning module includes a blade assembly mounted there on transverse to the path of movement of the cleaning module. The print apparatus further including selectively operable means for actuating the blade assembly during a select cleaning cycle to engage the leading end of its blade with the underside of the stencil as the cleaning module is passed beneath said stencil whereby the leading edge of the blade scrapes debris from the underside of said stencil. The stencil printing and cleaning method of the invention uses the steps of: dispensing a paste material through a stencil onto a substrate surface to define a given pattern thereon; and passing a cleaning module, provided with a scraping blade that can be extended above the module to contact the lower surface of the stencil to clean the underside thereof when the leading edge of the blade is in contact with the underside of the stencil.

### FIELD OF THE INVENTION

This invention generally relates to a screen printing apparatus for fabrication of substrates, circuit boards and other electronic circuit components, and more particularly relates to a method and apparatus for cleaning the mask, or stencil, utilized in such screen printing arrangements.

### BACKGROUND OF THE INVENTION

The complexity and compactness of present day electronic products requires increased packing density of various conductive circuit configurations on the surface of substrates, circuit boards, and other components. One method of accomplishing this is by a contact printing apparatus such as a 265 Infinity printer apparatus commercially available from DEK International of Flemington, N.J. Such machines print the desired pattern by depositing a conductive paste, such as solder paste, through a metal stencil directly onto the surface of the component. However, the precision of such printed patterns is often compromised by paste material and other debris accumulating on the stencil surface that contacts the surface of the component being printed.

At present, some such commercially available screen printers include various arrangements for facilitating the cleaning of the printing surface of the metal stencil after each printing step. For example, after a printing operation, one prior art printer automatically draws a paper strip across the printing surface of the stencil to wipe its operational surface. To enhance the cleaning of the stencil, selected chemical solvents are often disposed on to the paper strip just prior to, or during its engagement with the stencil surface. A subsequent additional step applies a vacuum through the cleaning paper to draw particles from the stencil to the paper as the paper wipes the stencil surface for a second time. Although these cleaning steps do remove some or even most of the paste residue from the printing face of the stencil they leave slight amounts of residue or debris on its printing surface of the stencil. After a number of substrates are printed it has been found such residue builds up and hardens on the printing surface of the stencil such that errors result in the pattern being printed resulting in a high substrate defect rate. To reduce this defect rate it is necessary, after printing twenty or so substrates to remove the stencil from the machine and clean the stencil face of the hardened material. This procedure results in increased machine downtime resulting in reduced production and increased cost of the component.

Additionally, as electronic assembles become smaller and denser, the printed patterns also become smaller, and cleaning of the stencil becomes more critical. In this instance the number of substrates that can be printed before of the stencils must be removed and cleaned of hardened material becomes reduced as even smaller amounts of such residues on the stencil face can cause undesirable increases in machine downtime and component scrap rate. Thus, a solution that would provide for a more complete cleaning of the printing stencils without extended machine downtime or reduced production has long been sought.

### SUMMARY OF THE INVENTION

A stencil printing apparatus for printing paste material in a given pattern on a substrate in the fabrication of electronic components and assemblies comprises a paste dispenser configured for dispensing paste material through a stencil onto the substrate to define the given pattern thereon, and a cleaning module for passing beneath the stencil to clean the underside thereof having a blade extending at an angle therefrom such that its leading edge can be engaged against the underside for scraping any adherent or hardened debris from the under side of the stencil as the cleaning module passes beneath the stencil.

In the printing method of the invention, a substrate, to be printed with a paste material, is disposed beneath a stencil having a pattern defined therein. It should be noted that the substrate can be a module, wafer, fixture, board or other component Paste is then dispensed, through the stencil, onto the underlying substrate to create, on the substrate, the pattern defined by the stencil. The printed substrate is then removed from beneath the stencil and the bottom of the stencil is cleaned to remove any excess paste material from the bottom of the stencil. This cleaning of the bottom of the stencil can be done in several steps. The first step consists of wiping the lower surface of the stencil with a liquid impregnated paper; the second step is a vacuum cleaning of the substrate and the third requires raising the leading edge of a blade into engagement with the underside of the stencil and passing the blade across the underside of the stencil to remove any debris not removed by the prior cleaning steps.

Accordingly, it is an object of the present invention to provide an improved method of cleaning a printing stencil employed in printing apparatus designed for depositing precise patterns of solder paste, solder flux paste, or other metallic alloys and pastes thereof on such substrates.

Another object of the present invention is to provide a method of employing a cleaning blade for cleaning hardened materials from the printing face of a stencil employed in stencil printing apparatus.

A still further object of the invention is to provide a blade assembly operable in conjunction with other cleaning devices in a stencil printing apparatus for cleaning the printing surface of the stencil.

Another object of the invention is to provide a printing apparatus that deploys a blade at an appropriate time in a select cycle of the printing apparatus for scraping the printing face or surface of the stencil.

These and other objects and features of the present invention will become further apparent from the following description taken in conjunction with the drawings.

### BRIEF DESCRIPTION OF THE DRAWINGS

FIG. 1 is a diagrammatic sectional view of the stencil printing apparatus of a preferred embodiment of the invention for printing a precise pattern of material, such as a solder paste, on a substrate in the fabrication of components for electronic assembles.

FIG. 2 is a view of the printing apparatus depicted in FIG. 1 and illustrates a first cleaning cycle of the apparatus, following the printing of the substrate;

FIG. 3 is an enlarged exploded view in perspective of the elements of the cleaning blade assembly shown in FIGS. 1 and 2;

FIG. 4 is an enlarged view in perspective of the cleaning blade assembly, whose elements are individually illustrated in FIG. 3; and

FIG. 5 is a view of the printing apparatus as embodiment of the invention illustrating a cleaning cycle utilizing operation of the blade assembly for cleaning the underside of the stencil in accordance with the invention.

### DESCRIPTION OF THE PREFERRED EMBODIMENT

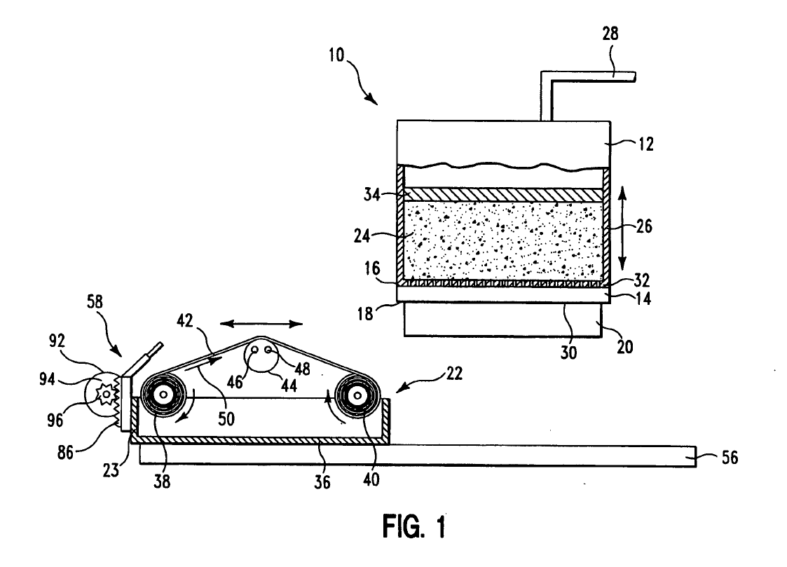

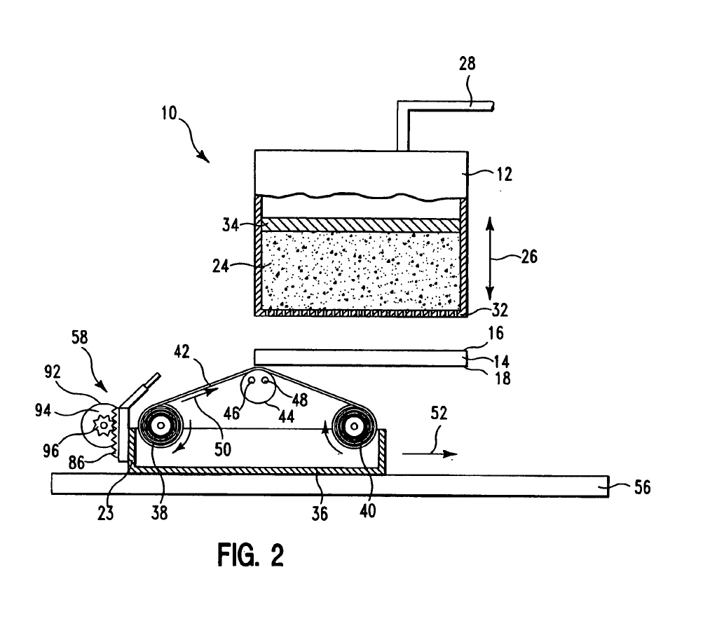

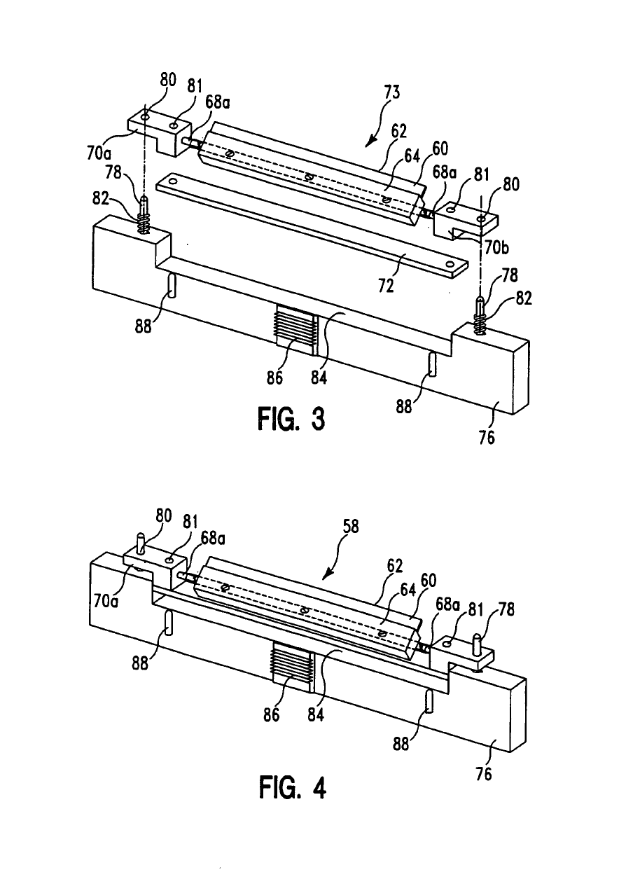

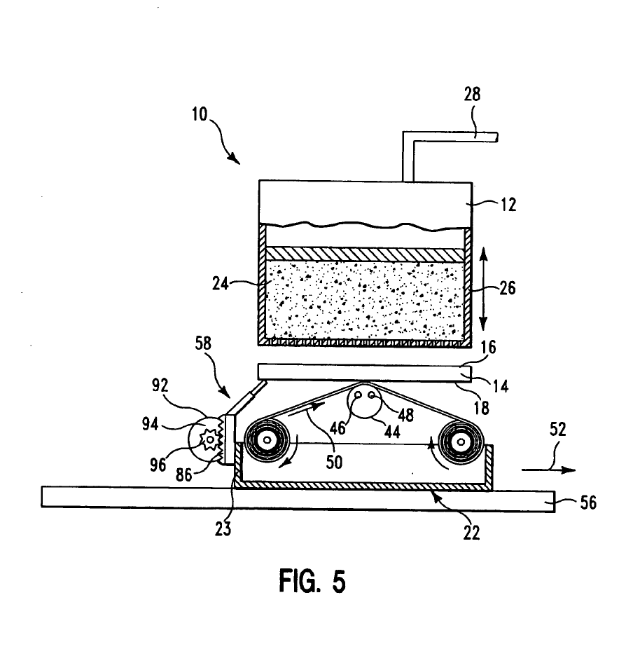

The preferred embodiment of the invention will now be described, with regard to the figures wherein: FIG. 1 is a diagrammatic sectional view of the stencil printing apparatus of a preferred embodiment of the invention FIG. 2 is a view of the printing apparatus depicted in FIG. 1; FIG. 3 is an enlarged exploded view in perspective of the elements of the cleaning blade assembly shown in FIGS. 1 and 2; FIG. 4 is an enlarged view in perspective of the cleaning blade assembly illustrated in FIG. 3; and FIG. 5 is a view of the preferred embodiment printing apparatus of the invention illustrating a cleaning cycle utilizing the blade assembly in accordance with the invention.

FIG. 1 is a diagrammatic cross-sectional view of a printer apparatus 10 and comprises: a paste dispensing head 12; a stencil 14 having an upper and lower surface 16 and 18 respectively; a substrate 20 for receiving the paste in the pattern defined by the stencil; and a cleaning module 22 positioned for cleaning of the stencil's lower surface 18.

The paste dispensing head 12 has an internal chamber 24, filled with a suitable viscous paste material, such as a solder paste 26, that is to be passed through the stencil 14 and deposited onto the upper surface 30 of the substrate 20 in a pattern defined by the stencil pattern, (not shown). It is, of course, to be understood that the stencil is designed to print the desired pattern required for of that particular substrate. A mesh, 32 is affixed to the bottom of the chamber 24 to aid in retaining the paste 26 in the otherwise open bottom of the chamber, until the paste is forced from the chamber 12 as will later be explained in detail with regard to operation of the printing apparatus 10.

The operation of the printing apparatus 10 is controlled by a computer system (not shown). This system, in conjunction with the monitoring of a variety of sensor signals from different areas and different operations of the apparatus, coordinates all steps in the process defined by the apparatus.

The process of printing a substrate consists of the steps of: selecting a stencil 14; filling the chamber 12 with a suitable solder paste 26; placing the stencil beneath and in contact with the under side of the chamber 12; placing the substrate 20 beneath and in contact with the underside 18 of the stencil; and pressurizing the chamber to force a select amount of the paste 26, from the chamber 12 through the stencil 14 where it is deposited on the surface 30 of the substrate 20.

The initial arrangement of the dispensing head 12, the stencil 14 and the substrate 20, in readiness for the actual printing step described above is shown in FIG. 1. The stencil 14, held in a fixed position by a frame, (not shown), is moved beneath and then up against the bottom 16 of the dispensing head 12 by any convenient elevating and positioning means. With the stencil properly positioned beneath the dispensing head 12, a substrate 20 is laterally transferred from a standby position, (not shown,) by any conventional means, such as a pick and place mechanism (not shown), into position beneath the stencil 14. Once in position it is also raised to bring its upper surface 30 in contact with the stencil's lower surface 18.

Next, pressure, via input 28, is applied to piston 34, in chamber 24, to force a selected amount of the paste 26 from the chamber 24, through the underlying mesh 32 and stencil 14 to replicate a paste deposit of the stencil's pattern on the upper surface 30 of the substrate 20. Once the specified amount of paste is deposited onto the surface 30, the pressure on piston 34 is relieved to stop the flow of paste onto the surface 30.

When necessary, additional paste can be added to the chamber by any conventional means, known to those skilled in the art, so that chamber will always be ready for another dispensing cycle.

At this time, the dispensing head 12 is raised to its standby position, as illustrated in FIGS. 2 and 5; the apparatus is then prepared for cleaning of the stencil to occur. Hence, as the head 12 is raised or just subsequent to thereto, the substrate 20 is dropped slightly to release it from engagement with the stencil's lower surface 18 and then shifted laterally there from, by a pick and place arrangement or any other conventional transfer means, not shown, to move the now printed substrate away from the printing position. This lateral movement of the substrate 20 leaves an open path for movement of the cleaning module 22 beneath the stencil 14 for cleaning the latter, and ultimately for the subsequent positioning of the next substrate in the vacated printing position.

The cleaning module 22, of the present invention, is illustrated, in section, in FIGS. 1, 2 and 5. As shown in these FIGS. 1, 2 and 5, the module is comprised of a carriage 36 carried on a support plate 56. The carriage 36 has an open top and supports therein a pair of spaced apart rolls, i.e., a feed roll 38 and a take up roll 40. Centrally positioned, above and between the rolls 38 and 40, is an axially sectioned or divided tube 44 having two sections 46 and 48, to provide means for applying either a vacuum or a liquid to the paper passing over the tube 44. The portion 46 is perforated and coupled to a suitable vacuum source (not shown). The portion 48 is also perforated and coupled to a liquid solvent dispensing means (not shown). A sheet of paper 42, from a roll of paper on the feed roll 38, is fed from the roll 38 over the tube 44 to take up roll 40. In accordance with the present invention, the cleaning module 22 further has a blade assembly 58 mounted thereon. This blade assembly 58, specifically illustrated in an exploded view in FIG. 3, is mounted on the trailing end 23 of the cleaning module 22.

In FIG. 3, this blade assembly 58 is comprised of a support member 64 provided with a blade 60, formed of a material as hard as the material forming the lower face 18 of the stencil 14. The blade 60 preferably is secured within a slot by any convenient means, such as screws, (not shown), in the support member 64, such that it can be readily removed for replacement or sharpening of its leading edge 62 as necessary. The support member 64 is bolted to a flat on a rod 66. At each end, the rod 66 carries extending round axles 68a and 68b configured for insertion in journals 70a and 70b respectively. These axles and journals are provided to permit positioning of the blade by rotation of the rod axles in the journals such that the leading edge 62 of the blade 60 can be positioned to contact the lower stencil face 18 at any desired angle. In the present apparatus, it was found that this angle should be approximately 60 degrees. Setscrews, (not shown) are used is to secure the rod axles in the journals such that the blade is held at the desired angle.

Once the journals 70a and 70b are each secured to a respective axle 68a, 68b, they are attached to a support member 72 that holds the journals in a fixed, spaced relationship to each other, to confine the rod 66 there between, thus forming a blade support subassembly 73. This sub assembly 73 is then mounted on a support bracket 76, which carries a pair of vertical spaced apart mounting posts 78 each of which is proved with a respective spring 82. The distance between these posts is such that each post will engage a respective mounting hole 80 in a respective one of the journals 70a and 70b.

As shown in these figures, the support bracket 76 is under cut, i.e. provided with a notch 84, between the posts, to accommodate the subassembly 73 there between such that there is sufficient clearance for journals to rest on the springs 82 of the mounting posts 78 without bottoming out on the bracket 76. Accordingly, the springs will maintain a specified force between the blade's leading edge 62 and the lower face 18 of stencil 14 when the blade is engaged with the stencil as explained below.

The support bracket 76 also carries a rack arrangement 86, as well as a pair of upright slots 88 spaced evenly on either side of and from the rack 86 the use of which will be described below. The slots 88 are arranged to hold blade assembly 58 on the trailing edge 90 of the support bracket and to maintain the alignment of the blade assembly as it is raised to force the blade edge 62 against the bottom surface 18 of the stencil 14.

A stepper motor 92, or other conventional means, is also mounted on the support plate 56 adjacent the trailing end of the carriage 22. This motor is positioned so that its shaft, carrying a gear 96 fixed in engagement with the rack 86 on the subassembly 73, will raise and lower the assembly 73 at specified times during the cleaning of the lower face 18 of the stencil 14.

Referring now to FIGS. 1, 2, and 5 the cleaning of the lower face 18 of the stencil 18 following the printing of the substrate 20, as taught above in conjunction with FIG. 1, will now be explained. Once the above-described printing step is complete, the printed substrate 20 is removed from beneath the stencil 14; the paste dispenser 12 is raised from the top of the stencil 14 and the control system, initiates cleaning of the lower face 18 of stencil 14 by delivering an appropriate activation signal to the cleaning module 22 to begin the first cleaning cycle. This first cleaning cycle is, a wet paper cycle and requires moving the module 22 from its start position, as shown in FIG. 1, to cause it to traverse the lower face 18 of stencil 14.

As noted previously the paper 42 passes over the tube 44 that is positioned between and higher than the rolls 38 and 40. The module 22 is raised, by the support plate 56 just as the tube 44 begins to pass beneath the leading edge of the stencil 14. This forces the paper, as it passes over the tube 44, into engagement with the lower face 18 to wipe the face 18 as the carriage traverses the stencil 14.

Simultaneously to enhance the cleaning of the face 18, the fluid dispensing section 46 of pipe 44 is filled with a paste dissolving solvent that wets the paper, as it passes over the tube 44. As the carriage 22 traverses beneath the face 18, fresh solvent wetted paper is drawn, from the roll 38, across the tube 44 and against the face 18, by the take-up rolls 40, such that the entire lower face 18 of stencil 14 is cleaned by fresh, solvent wetted paper. It is of course to be understood that the solvent dispensing pipe 46 is coupled to a controlled pressurized solvent source, (not shown) that will controllably dispense and deliver the solvent to the tube 44. Such an arrangement is within the skill of any competent engineer.

When the tube 44 reaches the trailing end of the stencil 14, the control system ceases delivery of solvent through tube 46, and lowers the support plate 56 so that the module 22 can return unhindered to its initial position and be ready to begin the second cleaning cycle. In the second cleaning cycle, the carriage 22 is again raised and caused to wipe, once again, the lower surface or face 18 of the stencil 14. Now however, instead of applying a solvent to the paper, a vacuum is applied to the paper as the paper passes over the tube 44, in contact with the lower surface or face 18 of stencil 14 to remove any loose particles or fibers from the lower stencil face 18. Again it is to be understood that that the vacuum is created by a suitable vacuum source coupled to the tube 44 that will apply and control the amount and delivery of the vacuum to the tube 44. Again such an arrangement is within the skill of any competent engineer. In this second cleaning cycle the vacuum, drawn through the paper 42 as it passes over the tube 44, pulls any loose or lightly held particles from the face 18 of stencil 14 on to the paper 42 being taken up on the take up roll 40.

Again, as the tube 44 reaches the far or trailing end of the stencil 14, the support plate 56 is lowered, the vacuum in the pipe 48 terminated and, at approximately the same time, the direction of travel of the cleaning module 22 is reversed to return the module 22 back to its start position.

Although the above-described procedure is adequate and removes the bulk of any paste deposited on the surface of the stencil, a residue remains and this residue can and does build up. This residue accumulates on the lower surface of the stencil especially around the openings in the stencil and hardens. In some instances, this hardened residue can clog an opening entirely or, at the very least, will reduce the size of an opening so that the amount of paste being passed on to the substrate is insufficient causing the created solder deposit, to vary and produce solder joints which are less reliable or anomalous. In other cases, such accumulations can cause the face of the stencil to fail to properly mate with the surface of the substrate being printed. This situation can cause too much solder to be deposited at selected points resulting in improper electrical characteristics or in undesired interconnections and/or short circuits in the circuit formed on the substrate surface again increasing substrate defect rate. Prior to the present invention the only way of avoiding these problems was to periodically shut down the machine on a regular basis in order to remove and replace the stencil. This increases the down time of the machine.

The present inventors have found, by introducing the present invention, i.e., the assembly 58 described in FIGS. 3 and 4 and adding a third cleaning step employing the assembly 58, that the above-described residue accumulation problems that create this substrate defect rate and/or machine downtime can be minimized if not avoided entirely.

The procedure that incorporates this third cleaning step and uses the above described blade assembly 58, shown in FIGS. 3 and 4, will now be described in detail with reference to FIGS. 3, 4, and 5.

The cleaning procedure of the invention begins this third cleaning step following completion of the first and second cleaning cycles described above. Immediately after the second cycle is completed, this third cycle begins. The support plate 56 again raises the cleaning module 22 just as the tube 44 begins to pass beneath the leading edge of the stencil 14. Again, this forces the paper, as it passes over the tube 44, into engagement with the lower face 18 to wipe the face 18 as the carriage traverses stencil. Again if desired the paper may be wetted with the paste dissolving solvent however this is generally unnecessary. Carriage 22 is now caused to begin to traverse beneath the face 18 and as the leading edge 62 of the blade 60 becomes positioned just beneath the leading edge of the stencil 14 the stepper motor 92 coupled to rack 86 is activated to raise bar 76, carrying the blade subassembly 73, to cause the leading edge 62 of the blade 60 to engage the lower surface 18 of stencil 14 and just compress the springs 82. Preferably, the edge 62 of blade 60 will form an angle approximate sixty degrees (60°) with respect to the stencil's lower surface 18. Because of the springs 82 the force with which the blade edge 62 contacts the lower face 18 of the stencil is constant. The module 22 now moves beneath the stencil 14 and the leading edge 62 of blade 60 scrapes the stencil's lower surface 18 clean of residue. When the cleaning module 22 reaches a point wherein the blade assembly 58 reaches the trailing end of the stencil 14, the stepper motor 92 is triggered and the blade assembly 58 is lowered. Simultaneously, the support plate 56 is lowered and the cleaning module 22 is returned to its start position.

It is to be noted that the stencil is typically formed of invar or stainless steel having a hardness between 70 and 97 HRB and the blade 60 is preferably formed of a similar material. A blade slightly harder than that of the material from which the stencil is formed has an improved ability to scrape residue off the lower side 18 of the stencil 30.

It should be noted that when the prior art, wet paper and vacuum cleaning cycles are regularly employed after printing of a substrate, the blade scraping step of the present invention may not need to be required after the printing of each substrate but should be employed once a selected number of substrates have been printed. The frequency of the scraping step of the invention is determined by the stencil and paste used for printing. However the present inventors have found that the typical stencil need only be scraped, in accordance with the present invention, only after twenty or more stencils have been printed. Additionally, whereas the blade cleaning step is described in the preferred embodiment in a third cycle following a wet paper and a vacuum cycle, it may be utilized alone, either before or after a respective one of these cycles or in conjunction with either or both of these cycles.

This completes the description of the preferred embodiment of the invention, and since changes may be made in the above construction without departing from the scope of the invention described herein, it is intended that all matter contained in the above description or shown in the accompanying drawings shall be interpreted in an illustrative and not in a limiting sense. Thus, other alternatives and modifications will now become apparent to those skilled in the art without departing from the spirit and scope of the invention.

1. A stencil printing apparatus configured for printing a selected material in a given stencil pattern on a substrate in the fabrication of electronic components, said printing apparatus comprising:
a stencil having an first surface and a second surface with openings defining a given pattern passing between said surfaces;
means for holding a substrate to be printed with said given pattern against said second surface of said stencil;
means for passing a selected material from said first surface of said stencil though said openings therein to print said material in given pattern on said substrate;
means for removing said printed substrate from said second surface;
a cleaning module;
means for passing said cleaning module along a selected path across said second surface for cleaning the second surface of the stencil following a printing operation,
said cleaning module including a blade assembly mounted thereon;
said blade assembly including a scraper blade having a leading edge extending therefrom;
means on said module for positioning said leading edge of said scraper blade against said second surface of said stencil and passing said leading edge across said second surface of said stencil to remove any residue of said selected material from said second surface as said cleaning module passes along said selected path.

2. A stencil printing method for printing paste material in a given pattern on a substrate, consisting of the steps of:
selecting a stencil having a first surface and a second surface with a given pattern defined there between;
selecting a substrate to have said pattern recreated thereon;
positioning said substrate against said second surface of said stencil;
dispensing a paste material on said first surface and forcing said paste material through said stencil to recreate, in said paste material, said given pattern on said substrate position against said second surface;
removing said substrate from against said second surface;
placing a cleaning module have a blade positioned thereon adjacent said second surface; and
extending said blade above said cleaning module into engagement with said second surface and passing said cleaning module across said second surface to scrape any paste material from said second surface.

3. The stencil printing apparatus of claim 1 wherein there is further provided:
a paste dispenser;
means for holding said paste dispenser adjacent a first surface of said stencil; and
means for directing said cleaning module, along a selected path along said second surface of said stencil, for cleaning said second side of said stencil in one or more cleaning cycles following a printing operation, and;
said blade is elongated in a direction generally normal to said selected path of said cleaning module.

4. The stencil printing apparatus of claim 3, wherein said blade can be extended to engage the second surface of said stencil at an angle of approximately sixty degrees.

5. The stencil printing apparatus of claim 3, wherein said blade can be extended to engage the second surface of said stencil at an angle between forty degrees and eighty degrees.

6. The stencil printing apparatus of claim 3 wherein:
said cleaning module has a leading edge and a trailing edge;
said leading edge being the first edge to pass across said second surface as said module begins its cleaning pass across said second surface;
said trailing edge being the last edge to pass across said second surface during said cleaning pass;
said blade assembly is mounted on the trailing edge of said cleaning module; and
said cleaning module has mounted thereon means for moving said blade from a retracted position in which said blade does not engage said second surface to an extended position wherein said blade does engage said second surface.

7. The stencil printing apparatus of claim 6 wherein:
said cleaning module travels in a fixed direction beneath said stencil;
the leading edge of said module being the first edge to pass under said stencil;
the trailing edge of said module being the last edge to pass under said stencil;
said blade assembly is mounted on said cleaning module near its trailing edge said module further includes elevator means for selectively raising and lowering said blade assembly to selectively engage with and disengage the blade from the second surface of said stencil as said cleaning module moves there under.

8. The stencil printing apparatus of claim 7, wherein:
said blade assembly is mounted on the trailing edge of said module.

9. The apparatus of claim 1 wherein said stencil is formed of metal.

10. The apparatus of claim 9 wherein said stencil is formed of stainless steel having a hardness of hardness between 70 and 97 HRB.

11. The apparatus of claim 11 wherein said blade is formed of stainless steel having a hardness of hardness greater than the hardness of said stencil.

12. The apparatus of claim 10 wherein said stencil is formed of Invar having a hardness of hardness between 70 and 97 HRB.

13. The apparatus of claim 12 wherein said blade is formed of Invar having a hardness of hardness greater than the hardness of said stencil.

14. A stencil printing apparatus configured for printing of paste material in a given pattern on a substrate, comprising
a paste dispenser;
a stencil for defining a given pattern on a substrate having upper and lower surfaces;
a cleaning module operable for traveling beneath said stencil for cleaning the lower surface thereof in one or more cleaning cycles following printing of said pattern on said substrate;
said module comprising means for carrying a cleaning paper thereon;
said module further carrying means for selectively applying a solvent to said paper;
said module further carrying means for selectively applying a vacuum to said paper:
said module further carrying a blade assembly mounted thereon;
said blade assembly including a blade having a leading edge extended in a given direction and at a selected angle from said assembly, and
selectively operable means for actuating said blade assembly to engage the leading end of said blade with said lower surface of said stencil as said cleaning module passes under said stencil such that the leading edge of said blade cleans debris from the lower surface of said stencil.

15. The method of claim 2, wherein;
the step of extending said blade consists of activating a mechanism provided on said module to raise the blade from a first position, where it does not engage the underside of said stencil, to a second position wherein the leading edge of said blade will engage the underside of said stencil just as the leading end of the blade carried on said assembly begins to pass under said stencil.

16. The method of claim 15, including the step of:
retracting said blade form said extended position to disengage the underside of said stencil.

17. The method of claim 16 wherein:
the step of retracting said blade from said extended position consists of activating said mechanism to disengage the blade from the underside of said stencil, just as the leading end of the blade carried on said assembly passes the trailing edge of said stencil.
